(19) United States
(12) Patent Application Publication
(10) Pub. No.: US 2004/0002313 A1
(43) Pub. Date: Jan. 1, 2004

(54) Signal level control

(76) Inventors: Allan Peace, Scoresby (AU); John Wright, Scoresby (AU)

Correspondence Address: Welsh & Katz, Ltd., THOMAS R. VIGIL, 22nd Floor, 120 South Riverside Plaza, Chicago, IL, 60606, US

(21) Appl. No.: 10/185,427

(22) Filed: Jun. 28, 2002

(51) Int. Cl. H04B 1/06; H04B 7/00

(52) U.S. Cl. 455/234.1; 455/232.1

(57) ABSTRACT

An audio level control system for dynamically controlling the level of an input audio signal 9 to provide an altered, level controlled output signal 10. The level control system includes a frequency band limiter 1, a tapped delay line 2, a signal level control stage in the form of a multiplier 3, a zero-crossing detector 6 and a transfer characteristic shaping unit 8. A signal whose level is to be controlled is put into the delay-line 2, and at each zero-crossing of the delayed signal, the maximum amplitude of the signal in the delay line 2 is determined and provided to the transfer characteristic shaping unit 8 which uses that value to adjust the amount of level control applied to the input signal in the level control stage multiplier 3. This provides dynamic level control that adjusts the output signal level gain depending on what the signal is about to do, rather than on the basis of what the signal has just done.

The present invention relates to a method of and an apparatus for signal level control, and in particular to match the dynamic range of the signal to the limits and dynamic range of a transmission or recording medium. It in particularly applicable to audio systems where the audio level must not exceed a given limit (e.g. for transmission or recording) and waveform distortion is undesirable.

The invention will be described with particular reference to radio transmissions, but it is, as will be appreciated by those skilled in the art, applicable not only to radio transmissions, but also to other audio signals and systems such as musical instruments, audio broadcasts, landlines, hearing aids, public address systems, etc., as well as non-audio signal systems where signal level control is required.

Many radio systems are required by regulation to limit their transmission modulation amplitude to prevent interference to radio users on an adjacent radio channel. At the same time, the radio system should maximise the modulation amplitude to maximise the robustness of the intelligibility of the, e.g. speech, signal being transmitted in the presence or noise and interference, while not losing intelligibility due to distortion of the signal.

Techniques have therefore been developed to dynamically control the modulation and amplitude level of the signal being transmitted, to try to maximise use of the available transmission modulation amplitude range but without exceeding that range. This is often referred to as “gain control”.

In a common gain control technique for in particular radio speech transmissions, the level (amplitude) of the transmitted speech waveform is controlled in a reactive automatic gain control manner in which the current speech envelope amplitude is measured and the gain (which is then applied to the following signal) adjusted accordingly to give a waveform that has an average amplitude slightly less than equal to the radio channel limits. A clipping limiter is then used to prevent the speech amplitude peaks from exceeding the radio channel amplitude limits. A low-pass filter is used to remove the high frequency distortion products that this clipping generates.

The Applicants have recognised a number of drawbacks to this technique.

Firstly, after a sudden loud transient signal, there will always be a trade-off between the distortion of the waveform, the rapidity of response, and the recovery of signal gain. It can be very difficult to find a good compromise that suits all waveforms.

Secondly, the clipping limiter removes some of the waveform (and in particular the waveform peak). This distorts the harmonic structure of the signal, which can reduce its intelligibility significantly. This can be even more pronounced when an emphasised channel is limited as the high frequency detail of the signal is disproportionately lost.

The Applicants believe therefore that there remains a need for an improved technique for signal level control.

According to a first aspect of the present invention, there is provided a method of dynamically controlling the level of a signal, comprising:

predicting what the level of the signal whose level is to be controlled will be and controlling the level of the signal on the basis of that prediction.

According to a second aspect of the present invention, there is provided an apparatus for dynamically controlling the level of a signal, comprising:

means for predicting what the level of the signal whose level is to be controlled will be; and

means for controlling the level of the signal on the basis of that prediction.

According to a third aspect of the present invention, there is provided a method of dynamically controlling the level of a signal, in which the signal whose level is to be controlled is passed to a level control stage in which its level is controlled, the method comprising:

providing a prediction of the level of the signal to be passed to the level control stage to the level control stage; and

controlling the level control stage to control the level of the signal based on the signal level prediction.

According to a fourth aspect of the present invention, there is provided an apparatus for dynamically controlling the level of a signal, comprising:

a level control means to which the signal whose level is to be controlled is passed for its level to be controlled;

means for providing to the level control means a prediction of the level of the signal to be passed to the level control means; and

means for controlling the level control means to control the level of the signal based on the signal level prediction.

In the present invention the level of the signal is controlled on the basis of the predicted signal level, in other words on the basis of what the signal is about to do, rather than on the basis of what the signal has just done as in the reactive prior-art techniques. This allows the signal level to be controlled more suitably and so avoid or reduce the problems discussed above in relation to the prior art techniques. For example, as the predicted signal level is used, the gain can be chosen sufficiently accurately that the waveform should not reach the clipping, peak limiter (thereby avoiding loss of information and distortion due to peak clipping), while still using the available signal range as far as possible. The present invention can also allow the signal waveform level to be controlled (scaled) to modulate the desired level range as fully as possible but without altering the overall signal waveshape (envelope).

The predicted signal level that the level control is based on can be selected as desired, e.g. as regards the signal position in advance that the prediction is for. Most preferably the prediction is for a particular portion of the signal and in a particularly preferred embodiment represents the peak predicted signal level for that signal portion (although the level control could be based on more sophisticated signal level predictions for the relevant signal portion if desired).

The signal portion whose level is predicted is preferably at least the next third of the signal waveform's period (or at least of a given frequency, e.g. the lowest, expected in the signal) and most preferably the signal level for the next half-cycle of the signal waveform (or at least of given, e.g. the lowest, frequency in the waveform) is predicted. These arrangements can ensure that the predicted signal level takes account of the next signal peak to arrive. This is therefore a convenient technique that still allows, for example, peak clipping to be reduced or avoided. Thus, in a particularly preferred embodiment it is the predicted peak signal level (amplitude) appearing in the relevant signal portion (e.g. next half-cycle (e.g. or the lowest signal frequency)) that the level control is based upon.

The signal level can be predicted as desired. Preferably this is done by determining (sampling) the level of a (the relevant) portion of the signal and advising the level control stage of that determined signal level before the relevant portion of the signal reaches the level control stage of the control process. Thus, for example, the signal whose level is to be controlled would be received at an input, and its level determined or estimated and that determined level passed to the level control stage before the relevant signal portion itself is passed to the level control stage.

Thus according to a fifth aspect of the present invention, there is provided a method of dynamically controlling the level of a signal, in which the signal whose level is to be controlled is passed to a level control stage in which its level is controlled, the method comprising:

determining the level of a portion of the signal to be passed to the level control stage and providing the determined level to the level control stage before the signal portion reaches the level control stage; and

controlling the level control stage to control the level of the signal portion based on the determined signal level.

According to a sixth aspect of the present invention, there is provided an apparatus for dynamically controlling the level of a signal, comprising:

a level control means to which the signal whose level is to be controlled is passed for its level to be controlled;

means for determining the level of a signal portion to be passed to the level control means;

means for providing to the level control the determined signal level before the signal portion reaches the level control means; and

means for controlling the level control means to control the level of the signal portion based on the determined signal level.

According to a seventh aspect of the present invention, there is provided a method of dynamically controlling the level of a signal, in which the signal whose level is to be controlled is passed to a level control stage in which its level is controlled, the method comprising:

providing an indication of the level of the signal to be passed to the level control stage to the level control stage before the signal reaches the level control stage; and

controlling the level control stage to control the level of the signal based on the signal level indication.

According to a eighth aspect of the present invention, there is provided an apparatus for dynamically controlling the level of a signal, comprising:

a level control means to which the signal whose level is to be controlled is passed for its level to be controlled;

means for providing to the level control means before the signal reaches the level control means an indication of the level of the signal to be passed to the level control means; and

means for controlling the level control means to control the level of the signal based on the signal level indication.

The determining of the signal level before it reaches the level control stage, and the passing of the signal measurement in advance to the level control stage can be achieved as desired. In a particularly preferred embodiment it is done by delaying the passage of the signal to the level control stage to allow the measured signal level to be passed to the level control stage before the signal itself arrives at the level control stage. This allows the system effectively to “react” to the signal level (e.g. peak) before it occurs. The delaying of the signal can be achieved, e.g., by storing it for a period, e.g. while the level is determined and passed on, and then releasing it to the level control stage. It is preferably achieved by passing the signal whose level is to be controlled through a delay means, such as a delay-line, before it reaches the level control stage. The signal level can then be measured (sampled) while the signal is in the delay means and those signal level measurements passed to the level control stage before the delayed, sampled, signal portion leaves the delay means and/or arrives at the signal level control stage.

Thus, according to a ninth aspect of the present invention, there is provided a method of dynamically controlling the level of a signal, comprising:

passing the signal whose level is to be controlled through a delay means;

determining the level of the signal in the delay means;

passing the delayed signal to a level control stage where the level of the signal is to be controlled, and

passing the determined signal level to the level control stage before the delayed signal reaches the level control stage, whereby the level control stage can use the determined signal level to control the level of the signal.

According to a eighth aspect of the present invention, there is provided an apparatus for dynamically controlling the level of a signal, comprising:

means for receiving a signal whose level is to be controlled;

a delay means,

a level control means for controlling the level of the signal whose level is to be controlled;

means for passing the signal whose level is to be controlled through the delay means;

means for determining the level of the signal in the delay means;

means for passing the delayed signal from the delay means to the level control means;

means for passing the determined signal level to the level control means before the delayed signal reaches the level control means; and

means for controlling the level control means to use the determined signal level to control the level of the signal whose level is to be controlled.

The delay of the signal can be selected as desired, but as discussed above, the delay arrangement preferably allows at least a predicted future maximum amplitude for at least the next third or half-cycle of the waveform's period to be passed in advance to the level control stage. The signal is preferably therefore delayed by a time proportional to the lowest frequency component of the signal, and the delay is thus preferably equal to at least a third of the period of the (expected) lowest frequency component in the signal whose level is to be controlled, and more preferably a time of the order of or equal to half a cycle of the lowest frequency component The signal could and is preferably therefore first passed through a frequency band limiter so as to at least establish a known reliable expected minimum frequency component for the signal to facilitate setting up the delay arrangement.

The way that the signal level of the signal in the delay means is determined can be selected as desired. Preferably, the signal level is sampled at a number of points in the delay means, i.e. at different points in time in the delayed signal. The maximum sample can then be used, for example, as a prediction of the peak level for the portion of the signal that the samples are taken over (e.g. the entire portion of the signal in the delay means).

The sampled signal portion (i.e. the portion of the signal over which samples are taken) in the delay means can be selected as desired, but as discussed above preferably represents at least a third, or the next half-cycle, of the waveform period. In the latter case, the sampled signal portion would then be preferably the portion of the signal between adjacent zero-crossings of the signal.

The number and spacing of the signal level samples can be selected as desired and should be selected so as to, for example, be likely to identify the peak levels for the expected frequency range of the signal whose level is to be controlled. Thus in a particularly preferred embodiment where the delay means is a delay line, the signal level is determined for plural, spaced, taps along the delay line. The sample spacings could all be equal or could vary, e.g. randomly, as desired.

Additional signal samples between the actual signal samples could be interpolated if desired, for example to allow for the signal samples taken possibly missing peaks in the sampled signal (which may for example, when a frequency close to a sub-harmonic of the sampling frequency is being sampled). In a more straightforward arrangement this latter possibility could be taken account of, if desired, by, for example, setting the signal control level a margin below the permitted maximum value (to allow for missed peaks). The margin could valid depending on frequency (e.g. be greater at expected “problem” frequencies). A peak limiting clipper could also be used to remove any “rogue” peaks that still appear.

The level control of the signal can be carried out as desired on the basis of the predicted signal level. In one preferred embodiment the level control is set to ensure that the maximum predicted signal level (e.g. peak amplitude) will reach but not exceed the permitted signal level range, such that peak clipping should be avoided and yet the maximum dynamic range of the signal used. This could be achieved, for example, by the level control stage scaling the signal by an amount inversely proportional to the predicted (indicated) maximum amplitude. Additionally, or alternatively, more sophisticated level control techniques (i.e. signal level transfer functions) could be used.

In one preferred embodiment, the signal level of the signal is multiplied in the level control stage by a factor inversely proportional to the predicted peak signal amplitude. This can be used to guarantee that the output, level-controlled signal will always have a peak amplitude which is equal to or less than a desired maximum amplitude, for all inputs.

In another preferred embodiment that is suitable for a signal peak limiting arrangement, the currently predicted (future) maximum signal amplitude is compared to a predetermined threshold level (amplitude) and if it exceeds the threshold, the signal level controlled to be lower. This level control, where necessary, is preferably achieved by, for example, dividing the threshold value by the predicted value and multiplying the signal by the result. If the predicted signal level does not exceed the threshold the signal level is preferably not adjusted (i.e. multiplied by one). In an alternative version of this arrangement, where infinite compression is desired, the signal could always be multiplied by the threshold level divided by the predicted level (rather than only when the predicted level exceeds the threshold level).

Other signal compression and expansion characteristics could be achieved by using different level control stage transfer characteristics as is known in the art. Several separate transfer characteristics could be combined to produce a more complex overall transfer characteristic as is known in the art, for example where it is desired to have combined limiting and compression. Matching compander (compression-expansion) pairs can also be made, and the feed-forward nature of the present invention helps to ensure accurate compander tracking.

The signal level control could be carried out at any time, and, for example, continuously. However, preferably the level control is set at intervals and not changed in between those intervals. In a particularly preferred embodiment, the level control is adjusted (if necessary) only at the zero-crossing points of the signal whose level is to be controlled. Thus the level control is adjusted at one more crossing point and then not changed until another (e.g. the next) zero-crossing point. Preferably level control is carried out at each zero crossing point of the signal. By adjusting the level control (i.e. the gain) at the zero-crossing points only, the signal level can be adjusted without discontinuities and with reduced distortion in the phase and amplitude of the processed signal waveform.

The zero-crossings can be determined as desired and in any suitable manner known in the art, for example by looking at when one of the signal samples in the delay means, such as the last one, crosses zero. Thus in the preferred embodiment where the signal is passed through a tapped delay line, the arrangement is preferably such that when the last tap or taps sense a zero-crossing, the maximum signal level currently sampled by the other taps is passed to the level control stage as a prediction of the maximum amplitude of the next portion of the signal.

It is believed that adjusting signal level control, particularly in the context of audio signal level control, and/or signal level control for radio transmission, only at zero-crossing points of a signal is advantageous in its own right. Thus, according to an eleventh aspect of the present invention, there is provided a method of dynamically controlling the level of a signal, in which a signal level control function is applied to a signal whose level is to be controlled, the method comprising only changing the signal level control function at the zero-crossing points of the signal whose level is to be controlled.

According to a twelfth aspect of the present invention, there is provided an apparatus for dynamically controlling the level of a signal, comprising:

means for applying a signal level control function to a signal whose level is to be controlled;

means for determining, the zero-crossing points of the signal whose level is to be controlled; and

means for controlling the means for applying the signal level control function such that the signal level control function is changed only at zero-crossing points of the signal whose level is to be controlled.

As discussed above, the input signal that is received and whose level is to be controlled is preferably first frequency band limited, e.g. by passing it through a band-pass filter, before it is passed to the level control circuit, as is known in the art. A peak clipper, again as is known in the art, can also be included after the level control stage for safety, to, for example, “catch” any very low frequency, high level transients that are too long for the delay means (although as noted above, in the normal course the present invention can be used to avoid any peak “clipping” except in unusual circumstances).

As will be appreciated by those skilled in the art, the present invention is applicable to signal level control generally. However, it is particularly suited to the level control of audio signals and in particular speech signals, particularly in the contact of (two-way) radio transmission of such signals. Thus according to yet further aspects of the present invention there are provided an audio level control system, and a radio transmitter, comprising the level control apparatus of any of the above aspects of the present invention.

The methods in accordance with the present invention may be implemented at least partially using software e.g. computer programs. It will thus be seen that when viewed from further aspects the present invention provides computer software specifically adapted to carry out the methods hereinabove described when installed on data processing means, and a computer program element comprising computer software code portions for performing the methods hereinabove described when the program element is run on data processing means. The invention also extends to a computer software carrier comprising such software which when used to operate a level control system comprising a digital computer causes in conjunction with said computer said system to carry out the steps of the method of the present invention. Such a computer software carrier could be a physical storage medium such as a ROM chip, CD ROM or disk, or could be a signal such as an electronic signal over wires, an optical signal or a radio signal such as to a satellite or the like.

It will further be appreciated that not all steps of the method of the invention need be carried out by computer software and thus from a further broad aspect the present invention provides computer software and such software installed on a computer software carrier for carrying out at least one of the steps of the methods set out hereinabove.

A number of preferred embodiments of the present invention will be described by way of example only, and with reference to the accompanying drawings, in which:

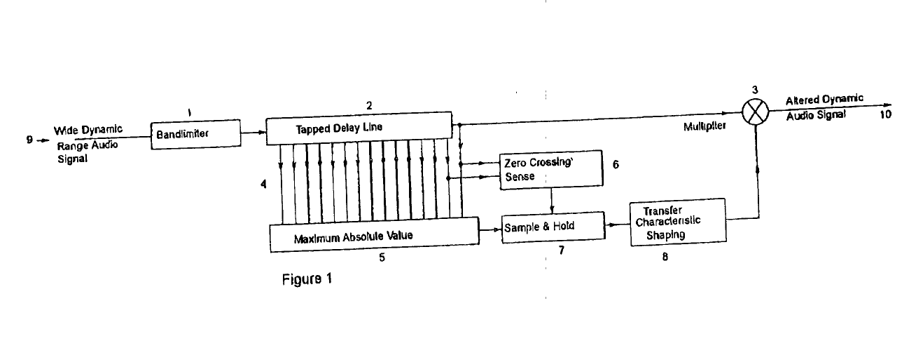

FIG. 1 shows schematically a signal level control system in accordance with the present invention;

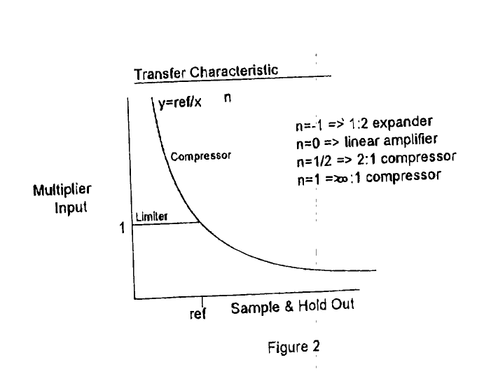

FIG. 2 is a graph showing an example of a transfer characteristic for the signal level control stage of the level control system of FIG. 1;

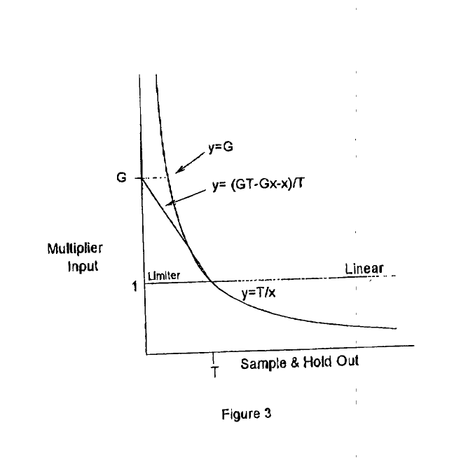

FIG. 3 is a graph showing the transfer characteristics of another suitable level control stage for the signal level control system of FIG. 1;

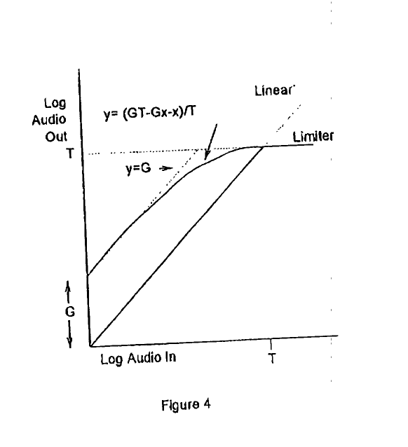

FIG. 4 is a graph showing the resulting signal transfer characteristics in logarithmic form when using the transfer characteristics of FIG. 3;

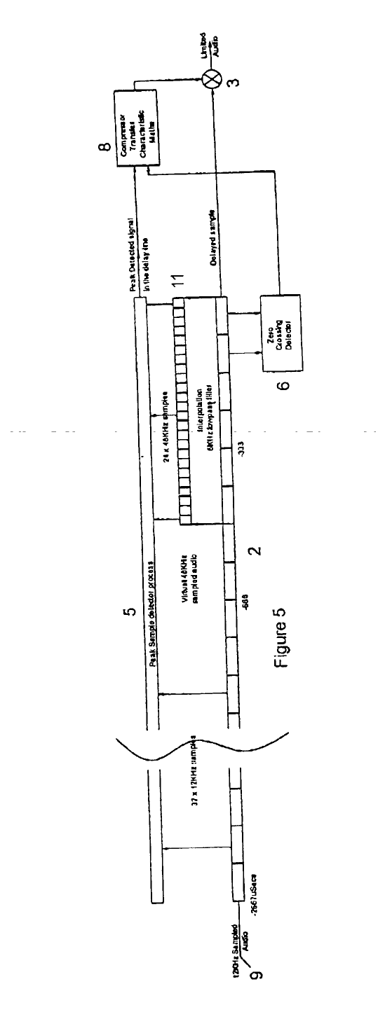

FIG. 5 shows schematically an arrangement for interpolating additional signal peak samples for the signal level control system of FIG. 1; and

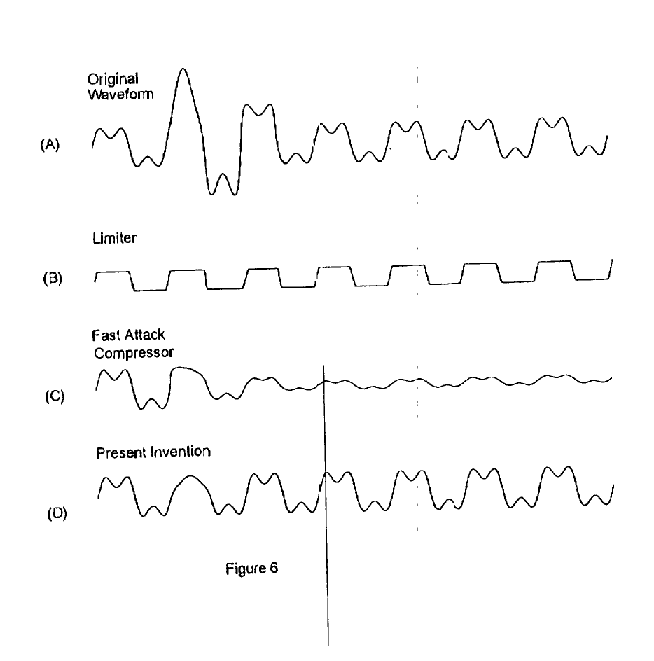

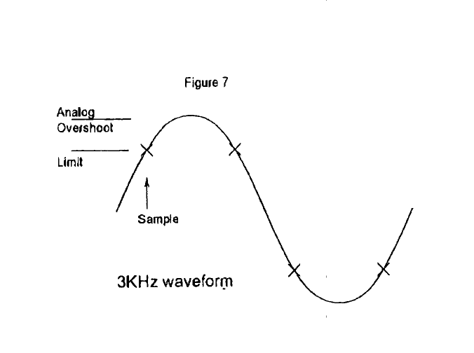

FIG. 6 is a diagram comparing waveforms generated using the present invention and prior art signal level control techniques.

A number of preferred embodiments of the present invention will now be described in relation to audio level control for a radio transmitter.

FIG. 1 shows schematically an audio level control system in accordance with the present invention. The system is intended to dynamically control the level of an input audio signal 9 (which could be being received for processing for radio transmission or broadcast, or recording onto a recording medium, etc.) to provide an altered, level controlled output signal 10. The level control system includes a frequency band limiter 1, a tapped delay line 3, and a signal level control stage in the form of a multiplier 3 (which multiplies its input signal by a given factor to provide an output signal).

The delay line 2 has a number of taps 4 which effectively sample the amplitude of different positions (in time) of whatever signal is in the delay line 2. The tapped values are passed to a maximum absolute value determining circuit 5 which determines the maximum absolute value being tapped (sampled) at any given time. The last tap of the delay line and a tap from the signal output from the delay line are input to a zero-crossing sensor 6 which detects when the signal leaving delay line is zero-crossing. The maximum absolute value circuit 5 passes the maximum value of any circuit at any time to a sample and hold circuit 7, which sample and hold circuit 7 releases its currently stored maximum value whenever the zero-crossing sensor 6 indicates a zero-crossing. The effect of this is that the maximum tapped (sampled) signal level (amplitude) in the delay line is output from the sample and hold circuit 7 at each zero-crossing but otherwise the output of the sample and hold circuit remains the same between zero-crossings.

The level value output from the sample and hold circuit 7 is provided to a transfer characteristic shaping unit 8 which uses that value to adjust the multiplying factor, i.e. amount of level control, applied to the input signal in the level control stage multiplier 3.

The delay line 2 should delay the signal by a time proportional to the lowest frequency component of the signal, and preferably by at least a third of the period of the lowest audio frequency allowed by the bandlimiter 1. In the present case, the frequency band passed by the band limiter and the delay line length are chosen to then ensure that the half-cycle waveform peak of the lowest bandpassed frequency is in the delay line at each half-cycle's zero-crossing (such that that peak (and all other passed frequency peaks) should therefore be sampled by the taps on the delay line at the time that the transfer characteristic for that half-cycle is being derived). For an audio speech signal in a radio transmitter, a preferred frequency bandlimiting pass is 300-3000 Hz. A suitable number of taps for the delay line would be 16, with a delay clock of 13 KHz and a delay length of 1.3 msecs.

In use of the level control system of FIG. 1, the input audio signal 9 which has a wide dynamic range is first bandlimited by being passed through the bandlimiter 1 and is then input to the tapped audio delay line 2. The zero-crossing sensor 6 detects each zero-crossing of the delay line output waveform and at those points the absolute value of the peak audio amplitude of the signal in the delay line 2 is calculated and stored by means of the maximum absolute value circuit 5 and the sample and hold circuit 7. This maximum absolute value is derived from the taps to the delay line 2 which effectively sample the audio signal still in the delay line. (The absolute value of the signal may also be calculated when the signal sample is added to the tapped delay line and stored in a separate delay line so that the absolute value does not have to be repeatedly recalculated. Likewise, the maximum absolute value need only be determined at each zero-crossing, if desired.)

The maximum absolute value provided by the sample and hold circuit 7 is effectively a prediction of the amplitude of the signal that will be reaching the signal level control stage multiplier 3 from the delay line 2 at some point in the future.

The transfer characteristic shaping unit 8 then uses the zero-crossing predicted peak audio amplitude from the sample and hold circuit 7 to control the level control stage multiplier 3 to provide an altered amplitude dynamic output audio signal 10. The level controlled output signal 10 can be provided to a further peak safety clipper so as to catch any very low frequency, high level transients that are too long for the delay line 2, if desired.

The invention can be implemented as desired, for example in hardware or as a digital signal processing algorithm.

Thus it can be seen that in effect the signal whose level is to be controlled is put into a short delay-line, and then at each zero-crossing of the delayed signal, the signal in the delay line is scanned and the gain is set depending on what is in the delay line, until the next zero-crossing where the process is repeated. This provides dynamic level control that adjusts the gain depending on what the signal is about to do, and allows very fast predictive level control with minimal distortion, since the gain adjustments are made at the zero-crossing points. The attack and decay times are determined by the length of the delay time which is preferably a half cycle of the lowest passed (i.e. expected) frequency component.

Thus the present embodiment uses a tapped delay-line to provide an accurate prediction of the future, maximum signal amplitude at the delay-line output. Knowing the future maximum amplitude for at least the next third of the waveform's period allows the delay-line's output waveform to be scaled by an appropriate amount at the commencement of each output half-cycle of the signal.

The way that the delayed input signal is altered in the level control stage 3 can be selected as desired, but as discussed above a primary use is to ensure that the altered output signal 10 does not exceed amplitude limits, etc., set for the, for example, transmission medium, e.g. radio channel, to which the altered dynamic output signal 10 is to be provided. The transfer characteristic shaping can be selected as desired to achieve the desired aim.

In one preferred arrangement the transfer characteristic unit 8 determines a variable that is inversely proportional to the predicted peak audio amplitude from the sample and hold unit 7 and the output signal from the delay line 2 is then modulated by the multiplier 3 by multiplying it by that variable. This can be used to ensure that the altered output signal 10 will always have a peak amplitude which is equal to or less than the limiting level for the radio channel for all inputs. Such a half-cycle multiplying factor will anticipate and correct the amplitude of the next half-cycle. When the next zero-crossing occurs, a new multiplying variable is derived depending on the sampled (i.e. predicted) maximum amplitude value for the next half-cycle and the process repeated and so on.

For peak limiting applications, the transfer characteristic shaping unit 8 preferably compares the predicted maximum signal amplitude stored at each zero-crossing against a preset limit or threshold signal level. If the predicted signal level exceeds the threshold, then the preset value is divided by the predicted maximum signal amplitude and the delay line output is multiplied by this value in the multiplier 3 until the next zero-crossing. If the predicted maximum signal amplitude does not exceed the threshold, then the output signal can be left unchanged (i.e. multiplied by one).

For infinite compression with this technique, the signal should always be multiplied by the threshold level divided by the measured maximum level, whether or not it exceeds the threshold level. (For radio transmission of speech signals, a suitable transfer characteristic would be to use a limiting compressor with the threshold signal level set to 95% of the radio channel's permitted maximum modulation.)

Other compression or expansion characteristics can be achieved by using different transfer characteristics for the transfer characteristic shaping unit 8. Several separate characteristics could be combined to produce a more complex overall transfer shaping characteristic where, for example, combined limiting and compression is desired. Matching compander pairs can also be made. The use of a feed-forward control loop in the present invention helps to ensure accurate compander tracking.

FIG. 2 shows an example graph of a suitable transfer characteristic for the transfer characteristic shaping unit 8. The x axis shows the output of the sample and hold unit 7, i.e. the sampled (predicted) maximum amplitude value of the signal in the delay line, and the y axis is the multiplier variable by which the signal from the delay line is multiplied to provide the level controlled output signal 10.

FIG. 2 shows a suitable transfer characteristic for both a peak limiting transfer characteristic and a compressing transfer characteristic. In FIG. 2 the sample and hold output value “ref” is the threshold peak amplitude. Above that amplitude the signal is always multiplied by a factor less than 1 to reduce its amplitude. Below that signal level in the limiter case the signal is simply multiplied by 1, whereas in the compressor case it is still multiplied by a variable but which this time is greater than 1.

For the transfer characteristic of FIG. 2, the multiplying factor is y-ref/xⁿ, i.e. the multiplying factor y is equal to the threshold signal amplitude divided by the sampled signal amplitude to the power n. The value of n affects the transfer characteristic. If n=−1, then the transfer characteristic acts as a 1:2 expander. If n=0, then the transfer characteristic is linear amplification. If n=½, then the transfer characteristic is a 2:1 compressor, and if n=1 then the transfer characteristic is an ∞:1 compressor.

A more sophisticated transfer characteristic suitable for two-way radio applications will now be described with reference to FIGS. 3 and 4.

In this case it is assumed that the bandlimiter is set to pass frequencies in the range 300-3000 Hz and the delay line has 16 taps at 12 KHz sample rate, which is equivalent to a delay length of 1.33 msec. This implies 300 Hz minimum frequency for correct half-cycle compression and 750 Hz for full cycle sensing (which means reduced second harmonic distortion from the peak limiter, if present, for frequencies where the full cycle, or more, is sensed).

The transfer characteristic can be expressed with reference to the following parameters.

| | |
|---|---|
| Input: | M = Predicted maximum signal amplitude for the |
| | next half cycle from the delay line taps |
| | (maximum signal “sample and hold” output) |
| | T = Limit threshold amplitude |
| | G = “Talkpower” enhancement gain (degree of |
| | compression audio boosting). (The value of |
| | G can be varied G − 1 implies limiting |
| | only, G = 2 would be light compression |
| | (6 dB boost), G − 4 would be normal speech |
| | compression (12 dB boost), G = 8 would be |
| | heavy speech compression (18 dB boost) and |
| | G = 16 would be extreme speech compression |
| | (24 dB boost) ) |
| Output | Y = Gain multiplier for the delay-line audio |
| | output, i.e. the multiplying variable for |
| | the multiplier 3. |

Using the above terms, then a limiting transfer characteristic is expressed by Y=T/M, a soft compression characteristic can be expressed by Y=(GT-GM-M) /T, and a hard compression characteristic can be expressed by Y=G.

In a preferred arrangement, the gain multiplier for the delay line output (i.e. the multiplier coefficient used by the multiplier 3) should be the smaller multiplier result (i.e. value Y) given by the limiting and the soft compression equations above, or the smaller multiplier result Y given by the limiting and the hard compression equation above (depending upon whether hard or soft compression is required).

FIG. 3 is a graph showing the transfer characteristics generated by these equations. FIG. 4 shows the resulting audio transfer characteristics in logarithmic form (dBin vs. dbout).

As discussed above, the number and spacing of the samples taken from the delay line should be such as to try to ensure that any signal peak at any expected (i.e. bandpassed) frequency in the delayed signal is sampled.

However, this may not always be possible. In particular for frequencies which are close to a sub-harmonic of the sampling frequency, the discrete samples may not measure the signal at exactly the peak of the waveform, such that the waveform's true peak value may be underestimated while the waveform is in the sampled form. For example when using a 12 KHz sample rate to reconstruct a 3 KHz analogue waveform, with equally spaced samples, then the sampling may miss the 3 KHz waveform peaks. This can lead to an underestimation of the peak level of about 3 dB depending on the phase relationship of the sampling frequency to the audio frequency. (The potential sampling errors generally will vary depending on the frequency relationships, but for example they will be infinite at the half sample frequency (6 KHz in this example), 6 dB at ⅓ sample frequency (4 KHz in this example), 3 dB at ¼ sample frequency (3 KHz in this example), 1.24 dB at ⅙th sample frequency (2 KHz in this example) and so on.)

This may not be considered sufficiently detrimental in practice for there to be a need for any modification to the level control system. For example this problem is unlikely to be significant for speech signals, although it may be more significant for sine wave tests and music. Therefore, for speech radio applications which are not broadcast radio where music is being reproduced, and the only desire is to produce band-limited, amplitude-limited speech that has good “talkpower”, there may be no need to compensate for this potential problem.

However, where it is desired to reduce this problem, this can be done as desired. For example, it could be allowed for in the predictive control by allowing a “safety margin” to the true level (e.g. channel) limit, perhaps with a peak clipping limiter used to catch the odd “rogue” peaks that may still appear after analog reconstruction, or a peak clipping limiter could be used simply to catch the overshooting peaks. The signal limit threshold could also be reduced at particular, expected “problem” frequencies, to provide a safety margin for these frequencies, i.e. a small amount of pre-emphasis used in the feed-forward absolute value path. Thus in the present example, the limit threshold (3 KHz) is preferably reduced by 3 dB at high frequencies. Additionally or alternatively, the amplitude of the waveforms that are expected to be erroneously sampled could be predicted by interpolating additional samples of those waveforms, for example by using a short interpolating FIR filter to reconstruct intermediate peak samples to the degree of accuracy required. This would be applicable where accuracy of high frequencies is required.

FIG. 5 shows schematically a suitable interpolation circuit. The input audio signal 9 is provided to the delay line 2 and maximum absolute values are sampled by a peak sample detector 5, as before. Again as before, a zero-crossing detector 6 determines a zero-crossing and at that point the peak detected signal is provided to the transfer characteristic shaping unit 8 which controls the level control stage multiplier 3 to provide the altered output signal 10 accordingly. However, in this arrangement, there is a further interpolation 6 KHz lowpass filter 11 which has the effect of providing a virtual 40 KHz sampled audio signal and provides 24, 40 KHz samples to the maximum of absolute value, peak sample detector unit 5. This has the effect of interpolating additional samples that should better convey the maximum amplitude of whatever peaks are in the waveform n the delay line.

It can be seen from the above that in the preferred embodiments of the present invention at least, the waveform amplitude is controlled on the basis of the predicted peak amplitude of the next half cycle of the audio signal waveform. By looking ahead to the peak of the next half cycle of the waveform, at each zero-crossing, the waveform can be scaled to modulate the channel fully without altering the waveshape. The gain can be chosen so that a peak limiter is never used so there is no loss of information due to peak clipping, yet the radio channel is fully modulated by the waveform. As the gain is changed at the waveform zero-crossings, there are no audible discontinuities in the phase or amplitude of the processed waveform.

As the signal gain correction is only changed at the signal zero-crossings, and the system anticipates and corrects the future signal's half cycle peak amplitude, then the signal waveshape and harmonic structure is substantially preserved while the signal envelope can either be reduced, completely removed or limited to a maximum value by a suitable choice of transfer characteristic shaping.

Thus unlike standard signal limiting mechanisms, the present invention can avoid the waveform shape being distorted or “flattened”. Furthermore, as the pre-emptive gain adjustment is always performed at the signal waveform zero-crossing (i.e. minimum voltage), the adjusted waveform does not have any first order discontinuities or waveform distortions due to gain adjustment. The wave-shape, harmonic structure, etc. of each half-cycle of the waveform is therefore preserved, whilst still ensuring that each half-cycle of the output is at the required level. The present invention can therefore give a more transparent compression/limiting effect, which is not obvious to the recipient (e.g. a listener in the case of a speech signal), and so it can, for example, increase the “talk power” of a speech signal.

FIG. 6 illustrates this. FIG. 6A shows an example original waveform. FIG. 6B shows the output when the original waveform is passed through a simple signal limiter. FIG. 6C shows the output when the original waveform is passed through a fact attack compressor. FIG. 6D shows the output when the original waveform is processed in accordance with the present invention. It can be seen that the output waveform in FIG. 6D is a closer match to the original waveform than for the other techniques.

The response to transients in the present invention is also more instant and does not persist beyond each transient so there is no “pumping” or “hang” effects as is common with reactive signal level control compressors. The predictive nature and feed-forward approach of the present invention can also ensure that the system does not become unstable or overshoot on transients and can be used to guarantee that no in-band (i.e. passed by the bandlimiter) audio signal component will exceed the permitted output amplitude limit at any time by more than the calculated amount (and this has been found to occur in practice only with test tones at specific sub-harmonics of the sample frequency, which effect can be suppressed by waveform interpolation to any required degree of accuracy or by a small amount of control loop emphasis, as discussed above, if desired). Furthermore, although the signal envelope's peak to mean ratio may be reduced, that is done without introducing any complex intermodulation products between the various signal frequency components.

The present invention therefore provides, at least in its preferred embodiments, a new transmitter audio processing system which can provide predictive audio amplitude control to optimise and limit transmitter deviation as required by RF spectrum management authorities but without introducing excessive audio distortion. The process allows the audio waveform's envelope to be modified, without introducing waveform distortions which reduce the clarity and intelligibility of the speech by intermodulating the speech frequency component. This is also done with no overshoot, other than sampling errors. The present invention thus allows signal waveforms, such as audio waveforms, to be matched to a (transmission or recording) medium with limited headroom and dynamic range without substantial alteration to the harmonic content of the signal and without overshoot.

Although the present invention has been described above in relation to audio, and in particular speech, signal level control, as noted above and as will be apparent to those skilled in the art, the techniques of the present invention are applicable wherever a signal envelope requires adjustment, such as, for example, to match the dynamic range of the signal to the limits and dynamic range of a transmission or recording medium. Thus as well as being useful for, for example, providing a constant or modified audio envelope for musical instruments, audio broadcasts, “two-way” radio transmitters, landlines, hearing aids, and public address systems, etc, it can be used for other non-audio signals as well.

1. A method of dynamically controlling the level of a signal, comprising:
predicting what the level of the signal whose level is to be controlled will be and controlling the level of the signal on the basis of that prediction.

2. A method of dynamically controlling the level of a signal, in which the signal whose level is to be controlled is passed to a level output signal to which its level is controlled, the method comprising:
providing a prediction of the level of the signal to be passed to the level control stage to the level control stage; and
controlling the level control stage to control the level of the signal based on the signal level prediction.

3. The method of claim 1 or 2, wherein the predicted signal level that the signal level control is based on comprises the signal level predicted for a particular portion of the signal.

4. The method of claim 3, wherein the predicted signal level that the signal level control is based on comprises the predicted peak signal level for the particular portion of the signal.

5. The method of claim 3 or 4, wherein the particular signal portion whose level is predicted comprises at least the next third of the waveform period of a given frequency expected in the signal.

6. The method of any one of the preceding claims, comprising, providing the prediction of the signal level by determining the level of a portion of the signal and advising the level control stage of that determined signal level before that portion of the signal reaches the level control stage.

7. The method of any one of the preceding claims, comprising receiving the signal whose level is to be controlled at an input determining the level of the signal, and passing the determined signal level to the level control stage before the relevant signal portion itself is passed to the level control stage.

8. A method of dynamically controlling the level of a signal, in which the signal whose level is to be controlled is passed to a level control stage in which its level is controlled, the method comprising:
determining the level of a portion of the signal to be passed to the level control stage and providing the determined level to the level control stage before the signal portion reaches the level control stage; and
controlling the level control stage to control the level of the signal portion based on the determined signal level.

9. A method of dynamically controlling the level of a signal, in which the signal whose level is to be controlled is passed to a level control stage in which its level is controlled, the method comprising:
providing an indication of the level of the signal to be passed to the level control stage to the level control stage before the signal reaches the level control stage; and
controlling the level control stage to control the level of the signal based on the signal level indication.

10. The method of any one of claims 6 to 9, comprising delaying the passage of the signal to the level control stage to allow the determined signal level no be passed to the level control stage before the signal itself arrives at the level control stage.

11. The method of claim 10, wherein the signal whose level is to be controlled is delayed by passing the signal through a delay means before it reaches the level control stage.

12. A method of dynamically controlling the level of a signal, comprising:
passing the signal whose level is to be controlled through a delay means;
determining the level of the signal in the delay means;
passing the delayed signal to a level control stage where the level of the signal is to be controlled; and
passing the determined signal level to the level control stage before the delayed signal reaches the level control stage, whereby the level control stage can use the determined signal level to control the level of the signal.

13. The method of claim 10, 11 or 12, wherein the signal is delayed by a time period proportional to the expected lowest frequency component of the signal.

14. The method of any one of the preceding claims, comprising first passing the signal whose level is to be controlled through a frequency band limiter so as to establish a known expected minimum frequency component for the signal.

15. The method of any one of the preceding claims, wherein the signal level is controlled so as to ensure that the maximum predicted signal level will reach but not exceed a permitted signal level range.

16. The method of any one of the preceding claims, wherein the signal level is controlled by the level control stage scaling the signal by an amount inversely proportional to the maximum predicted signal level.

17. The method of any one of the preceding claims, comprising comparing the current maximum predicted signal level to a predetermined threshold signal level, and if it exceeds the threshold, controlling the signal level to be lower.

18. The method of any one of the preceding claims, comprising setting the signal level control at intervals, and not changing the signal level control in between those intervals.

19. The method of any one of the preceding claims, wherein the signal level control is adjusted only at the zero-crossing points of the signal whose level is to be controlled.

20. A method of dynamically controlling the level of a signal, in which a signal level control function is applied to a signal whose level is to be controlled, the method comprising only changing the signal level control function at the zero-crossing points of the signal whose level is to be controlled.

21. An apparatus for dynamically controlling the level of a signal, comprising:
means for predicting what the level of the signal whose level is to be controlled will be; and
means for controlling the level of the signal on the basis of that prediction.

22. An apparatus for dynamically controlling the level of a signal, comprising:
a level control means to which the signal whose level is to be controlled is passed for its level to be controlled;
means for providing to the level control means a prediction of the level of the signal to be passed to the level control means; and
means for controlling the level control means to control the level of the signal based on the signal level prediction.

23. The apparatus of claim 21 or 22, wherein the predicted signal level that the signal level control is based on comprises the signal level predicted for a particular portion of the signal.

24. The apparatus of claim 23, wherein the predicted signal level that the signal level control is based on comprises the predicted peak signal level for the particular portion of the signal.

25. The apparatus of any one of claims 21 to 24, wherein the means for providing the prediction of the signal level comprises means for determining the level of a portion of the signal and means for advising the level control means of that determined signal level before that portion of the signal reaches the level control means.

26. An apparatus for dynamically controlling the level of a signal, comprising:
a level control means to which the signal whose level is to be controlled is passed for its level to be controlled;
means for determining the level of a signal portion to be passed to the level control means;
means for providing to the level control the determined signal level before the signal portion reaches the level control means; and
means for controlling the level control means to control the level of the signal portion based on the determined signal level.

27. An apparatus for dynamically controlling the level of a signal, comprising:
a level control means to which the signal whose level is to be controlled is passed for its level to be controlled;
means for providing to the level control means before the signal reaches the level control means an indication of the level of the signal to be passed to the level control means; and
means for controlling the level control means to control the level of the signal based on the signal level indication.

28. The apparatus of any one of claims 21 to 26, further comprising delay means for delaying the signal whose level is to be controlled before it reaches the level control means.

29. The apparatus of claim 28, wherein the delay means comprises a delay line.

30. An apparatus for dynamically controlling the level of a signal, comprising:
means for receiving a signal whose level is to be controlled;
a delay means;
a level control means for controlling the level of the signal whose level is to be controlled;
means for passing the signal whose level is to be controlled through the delay means;
means for determining the level of the signal in the delay means;
means for passing the delayed signal from the delay means to the level control means;
means for passing the determined signal level to the level control means before the delayed signal reaches the level control means; and
means for controlling the level control means to use the determined signal level to control the level of the signal whose level is to be controlled.

31. The apparatus of any one of claims 28 to 30, comprising means for sampling the signal level of the signal in the delay means at a number of points in the delay means.

32. The apparatus of claim 31, wherein the delay means is a delay line, and the signal level is determined for plural, spaced, taps along the delay line.

33. The apparatus of any one of claims 21 to 32, further comprising a frequency band limiter for establishing a known expected minimum frequency component for the signal.

34. The apparatus of any one of claims 21 to 33, wherein the signal level is controlled so as to ensure that the maximum predicted signal level will reach but not exceed a permitted signal level range.

35. The apparatus of any one of claims 21 to 34, wherein the level control means comprises means for scaling the signal by an amount inversely proportional to the maximum predicted signal level.

36. The apparatus of any one of claims 21 to 35, further comprising means for comparing the current maximum predicted signal level to a predetermined threshold signal level.

37. The apparatus of any one of claims 21 to 36, further comprising means for determining the zero-crossing points of the signal whose level is to be controlled.

38. An apparatus for dynamically controlling the level of a signal, comprising:
means for applying a signal level control function to a signal whose level is to be controlled;
means for determining the zero-crossing points of the signal whose level is to be controlled; and
means for controlling the means for applying the signal level control function such that the signal level control function is changed only at zero-crossing points of the signal whose level is to be controlled.

39. The apparatus of claim 37 or 38, wherein the apparatus includes a delay means through which the signal whose level is to be controlled is passed, and the means for determining the zero-crossing points of the signal comprise means for determining when one of the signal samples in the delay means crosses zero.

40. An audio level control system comprising the level control apparatus of any one of claims 21 to 39.

41. A radio transmitter comprising the level control apparatus of any one of claims 21 to 39.

42. A computer program element comprising computer software code portions for performing the method of any one of claims 1 to 30 when the program element is run on data processing means.

43. A method of dynamically controlling the level of a signal substantially as hereinbefore described with reference to any one of the accompanying drawings.

44. An apparatus for dynamically controlling the level of a signal substantially as hereinbefore described with reference to any one of the accompanying drawings.
